(19) United States
(12) Patent Application Publication
(10) Pub. No.: US 2002/0181497 A1
(43) Pub. Date: Dec. 5, 2002

(54) METHOD AND APPARATUS FOR CONVERTING AND DIRECTING COMMUNICATIONS BETWEEN DEVICES OPERATING UNDER AN IEEE 1394 SERIAL BUS NETWORK PROTOCOL AND DEVICES OPERATING UNDER ANOTHER PROTOCOL

(76) Inventors: YOSHIZUMI MANO, CUPERTINO, CA (US); HAROLD A. LUDTKE, SAN JOSE, CA (US); SCOTT D. SMYERS, SAN JOSE, CA (US)

Correspondence Address: HAVERSTOCK & OWENS LLP, 162 NORTH WOLFE ROAD, SUNNYVALE, CA, 94086, US

(21) Appl. No.: 09/189,818

(22) Filed: Nov. 10, 1998

(51) Int. Cl. H04L 12/56

(52) U.S. Cl. 370/466; 370/402

(57) ABSTRACT

A protocol converter appropriately converts communications directed from a device operating under a first protocol to a device operating a second protocol. The converter is coupled to the two devices and converts communications between the devices into the appropriate format for the receiving device. The converter preferably includes a programmable microprocessor which manipulates communications into the proper format for the receiving device and then transmits the manipulated communications to the receiving device. Preferably, the converter is coupled between two bus structures of different protocols, where one of the bus structures is an IEEE 1394-1995 bus structure. Alternatively, the converter and the devices are all coupled to the same bus structure. A protocol conversion program is preferably stored within a read only memory (ROM) and used by the microprocessor to perform the appropriate conversions. Alternatively, the programmable microprocessor is programmed for the appropriate conversions by a device coupled to the converter. To communicate with a device using a second protocol, a device using a first protocol sends the communication intended for the device using the second protocol to the protocol converter. After receiving a communication sent from a device using the first protocol, the protocol converter manipulates the communication into the appropriate format for the device using the second protocol. The manipulated communication is then transmitted to the device using the second protocol.

### FIELD OF THE INVENTION

The present invention relates to the field of communications between devices within a network configuration operating under multiple protocols. More particularly, the present invention relates to the field of converting and directing communications between devices, operating under different protocols, within a network configuration.

### BACKGROUND OF THE INVENTION

The IEEE 1394 standard, “IEEE 1394 Standard For A High Performance Serial Bus,” Draft ratified in 1995, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. An example of an ideal application for the transfer of data isochronously would be from a video recorder to a television set. The video recorder records images and sounds and saves the data in discrete chunks or packets. The video recorder then transfers each packet, representing the image and sound recorded over a limited time period, during that time period, for display by the television set. The IEEE 1394-1995 standard bus architecture provides multiple channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394-1995 standard provides a high-speed serial bus for interconnecting digital devices thereby providing a universal I/O connection. The IEEE 1394-1995 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394-1995 standard is very thin in size compared to other bulkier cables used to connect such devices. Devices can be added and removed from an IEEE 1394-1995 bus while the bus is active. If a device is so added or removed the bus will then automatically reconfigure itself for transmitting data between the then existing nodes. A node is considered a logical entity with a unique address on the bus structure. Each node provides an identification ROM, a standardized set of control registers and its own address space.

The IEEE 1394-1995 standard defines, a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-1995 cable. The physical layer 16 also provides arbitration to ensure that all devices coupled to the IEEE 1394-1995 bus have access to the bus as well as actual data transmission and reception. The link layer 14 provides data packet delivery service for both asynchronous and isochronous data packet transport. This supports both asynchronous data transport, using an acknowledgement protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources, and basic notification of errors.

There are network configurations and protocols other than IEEE 1394-1995 which are used to connect devices together. These networks generally use power lines, coaxial cable, twisted pair phone lines or another appropriate link to connect the devices together. The devices within these networks are typically coupled together, either through a daisy-chain or star configuration. Through these links the devices within the network communicate with each other or allow control of devices within the network from a single device. Examples of such network protocols are CEBus, Lonworks and AVBus. Other examples of higher network protocols used within a network of devices include the common application language (CAL) and Generic CAL protocols.

Devices such as home appliances, environmental control systems, security systems and maintenance systems are typically controlled through a single-purpose interface tool such as a small control panel mounted on a wall within the home. An example of an environmental control system typically controlled in this manner is a home's heating/air-conditioning unit. An example of a maintenance system typically controlled in this manner is a landscaping irrigation system. Typically, such a landscaping irrigation system includes a wall mounted control panel within the house which is coupled through sets of wires to valves within the yard. By sending current through the sets of wires, the control panel controls the valves which release water to the sprinkler heads. A user or homeowner can program the control panel to periodically open the valves for specified periods of time. This type of control panel is generally necessary for each different type of system included within the house.

A menu-driven user interface for a CLBus network is taught by Yale Fujita and Steve Lam in “Menu-Driven User Interface For Home System,” IEEE WPM 15.4, 256-257, 1994. This interface provides an on-screen menu system which is generated by a system controller and displayed on a television within the network. Through this interface a user can control any of the devices coupled to the network. Different types of devices can be coupled to a CEBus network, including security, lighting control, irrigation, environmental control systems, communication and audio-video (A/V) devices. Control is effected through this interface and is displayed on a television. According to Fujita and Lam, a user can control any of these types of systems using this television interface. However, this interface only provides control of the devices within the CEBus network, operating according to the CEBus protocol. In such a network there is no manner for controlling devices operating under other protocols. Devices within other networks, as listed above, are configured and controlled in a similar manner.

What is needed is a method and apparatus for communicating between devices operating under different protocols. What is further needed is a method and apparatus for controlling communications between devices within two networks operating under different protocols.

### SUMMARY OF THE INVENTION

A protocol converter appropriately converts communications directed from a device operating under a first protocol to a device operating under a second protocol. The converter is coupled to the two devices and converts communications between the devices into the appropriate format for the receiving device. The converter preferably includes a programmable microprocessor which manipulates communications into the proper format for the receiving device and then transmits the manipulated communications to the receiving device. Preferably, the converter is coupled between two bus structures of different protocols, where one of the bus structures is an IEEE 1394-1995 bus structure. Alternatively, the converter and the devices are all coupled to the same bus structure. A protocol conversion program is preferably stored within a read only memory (ROM) and used by the microprocessor to perform the appropriate conversions. Alternatively, the programmable microprocessor is programmed for the appropriate conversions by a device coupled to the converter. To communicate with a device using a second protocol, a device using a first protocol sends the communication intended for the device using the second protocol to the protocol converter. After receiving a communication sent from a device using the first protocol, the protocol converter manipulates the communication into the appropriate format for the device using the second protocol. The manipulated communication is then transmitted to the device using the second protocol.

### BRIEF DESCRIPTION OF THE DRAWINGS

FIG. 1 illustrates a protocol defined by the IEEE 1394-1995 standard.

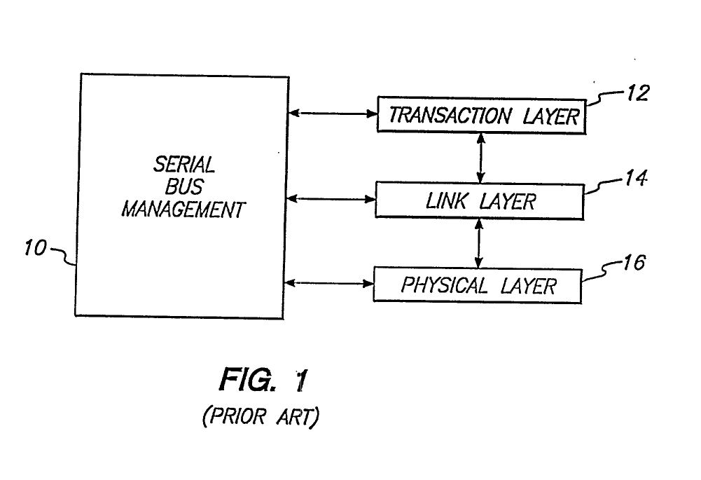

FIG. 2 illustrates a converter of the preferred embodiment of the present invention coupled between an IEEE 1394-1995 serial bus network and a CEBus network.

FIG. 3 illustrates a schematic block diagram of the protocol converter of the preferred embodiment of the present invention.

FIG. 4 illustrates a converter of an alternate embodiment of the present invention.

FIG. 5 illustrates a schematic block diagram of the protocol converter according to an alternate embodiment of the present invention.

### DETAILED DESCRIPTION OF THE PREFERRED EMBODIMENT

A protocol converter of the present invention appropriately converts communications directed from a device operating under a first protocol to a device operating under a second protocol. The protocol converter is coupled to the two devices and converts communications between the devices into the appropriate format for the receiving device. The converter includes a microprocessor capable of running a protocol conversion program to manipulate communications into the proper format and then transmit the manipulated communications to the receiving device. Preferably, the converter is coupled between two bus structures of different protocols, where one of the bus structures is an IEEE 1394-1995 bus structure. Alternatively, the converter and the devices are all coupled to the same bus structure. A protocol conversion program is preferably stored within a read only memory (ROM) in the converter and used by the microprocessor to perform the appropriate conversions. Alternatively, the protocol conversion program is loaded into the protocol converter by a device coupled to the converter. In still a further alternate embodiment, the protocol converter includes fixed firmware for performing the appropriate conversions. In the preferred embodiment, as communications are directed from the IEEE 1394-1995 bus structure to devices on the other bus structure, the converter will manipulate those communications into the appropriate protocol for communications on the other bus structure. As communications are directed from the other bus structure to devices on the IEEE 1394-1995 bus structure, the converter will manipulate those communications into the appropriate protocol for communications on the IEEE 1394-1995 bus structure.

The preferred embodiment of the protocol converter of the present invention permits IEEE 1394-1995 devices to discover and control unmodified, compliant devices of other protocols, including CEBus devices. The protocol converter also permits intelligent devices of other protocols to discover and control unmodified IEEE 1394-1995 devices. Using the protocol converter of the present invention, an intelligent IEEE 1394-1995 device can discover a “dumb” CEBus device, such as a light switch, and control all functions of that device as if the CEBus device was directly connected to the IEEE 1394-1995 device. A CEBus device can also discover and control an unmodified IEEE 1394-1995 device using the protocol converter of the present invention.

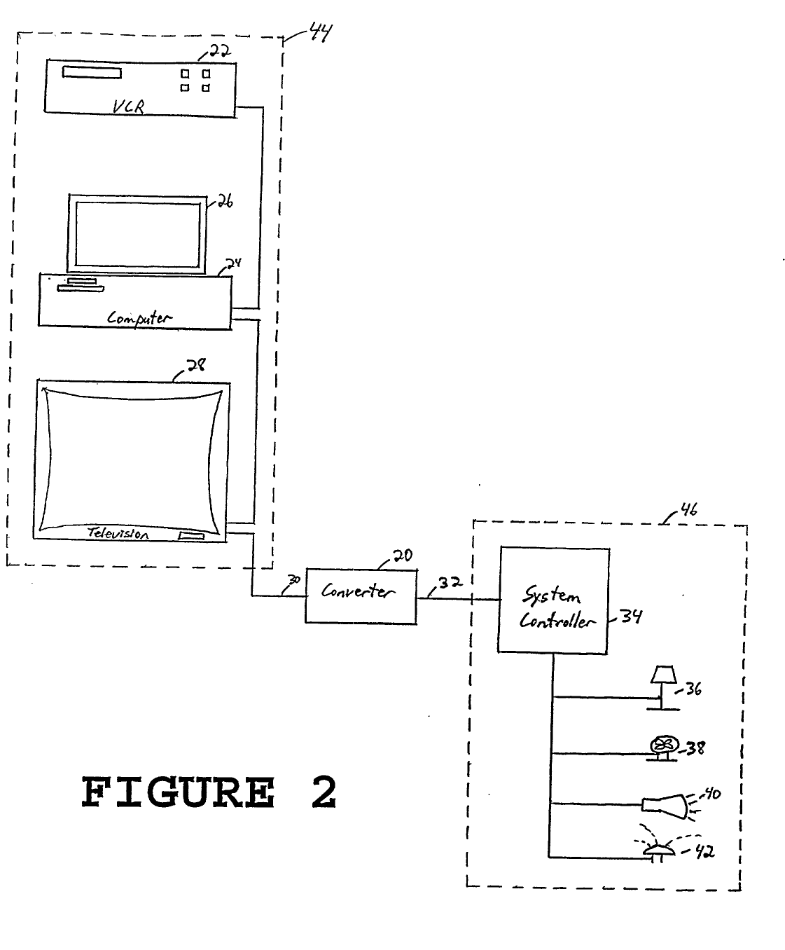

A block diagram of a protocol converter according to the preferred embodiment of the present invention, coupled between an exemplary IEEE 1394-1995 serial bus network and an exemplary CEBus network is illustrated in FIG. 2. The IEEE 1394-1995 serial bus network 44 includes a video cassette recorder (VCR) 22 coupled to a computer 24. The computer 24 also includes an associated monitor 26. A television 28 is coupled to the computer 24 and to the converter 20. The VCR 22, computer 24 and television 28 are all coupled together and to the converter 20 by an IEEE 1394-1995 serial bus network 30.

The CEBus network 46 includes a system controller 34 coupled to the converter 20 by the CEBus 32. Within the CEBus network 46, the system controller 34 is also coupled to control a lighting system 36, an air-conditioning and heating system 38, a security system 40 and an irrigation system 42 by the CEBus 32.

The systems coupled together within the CEBus network 46 are systems with which components coupled within the IEEE 1394-1995 serial bus network 44 would not normally be able to communicate. However, the protocol converter 20 of the present invention allows communications to be sent between the components within the IEEE 1394-1995 serial bus network 44 and the CEBus network 46. When communications are sent from a component within the IEEE 1394-1995 serial bus network 44 to a component within the CEBus network 46, the converter 20 converts the communication to the proper format for a communication within the CEBus network 46 and directs that communication to the proper component. Similarly, when communications are sent from a component within the CEBus network 46 to a component within the IEEE 1394-1995 serial bus network 44, the converter 20 converts the communication to the proper format for a communication within the IEEE 1394-1995 serial bus network 44 and directs that communication to the proper component.

In this manner, a component within the IEEE 1394-1995 serial bus network 44, such as the computer 24, can be used to control systems within the CEBus network 46, such as the irrigation system 42. By sending communications through the converter 20, the computer 24 can send control signals to the irrigation system 42, to appropriately turn on and off one or more zones of sprinklers controlled by the irrigation system 42. In a configuration as illustrated in FIG. 2, a user has the capability to control the systems within the CEBus network 46 from a single location and device such as the computer 24, by programming the computer 24 to control the irrigation system 42 and other systems, thereby eliminating the need for a separate wall-mounted control panel for each system.

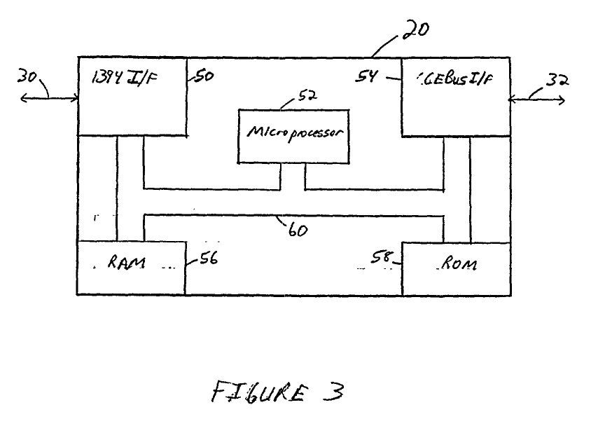

A detailed block diagram schematic of the converter 20 of the preferred embodiment is illustrated within FIG. 3. The protocol converter 20 includes an IEEE 1394-1995 interface circuit 50, a CEBus interface circuit 54, a microprocessor 52, a random access memory (RAM) 56 and a ROM 58, all coupled together by a system bus 60. The IEEE 1394-1995 interface circuit 50 is also coupled to the IEEE 1394-1995 serial bus 30 to receive communications from and send communications to the devices coupled within the IEEE 1394-1995 serial bus network 44. The CEBus interface circuit 54 is also coupled to the CEBus 32 to receive communications from and send communications to the devices coupled within the CEBus network 46. Preferably, the ROM 58 includes the protocol conversion program, used by the microprocessor 52 to convert communications into the proper protocol for the device to which the communication is intended. The ROM 58 also preferably stores identifying information about the protocol converter 20 which is provided to other IEEE 1394-1995 devices. The RAM 56 is available for general use by the microprocessor 52 during execution of the protocol conversion program and operation of the converter 20.

Each IEEE 1394-1995 device includes a configuration ROM which includes information about the device. This configuration ROM is mapped into the IEEE 1394-1995 address space of each IEEE 1394-1995 node. The configuration ROM for a device is therefore visible to all other IEEE 1394-1995 devices using normal IEEE 1394-1995 defined read transactions. The protocol converter 20 of the present invention is an IEEE 1394-1995 compliant device and accordingly includes a configuration ROM. In the preferred embodiment of the present invention, the ROM 58 implements the configuration ROM and includes the identifying information for the protocol converter 20. Alternatively, the configuration ROM is implemented by a separate, dedicated ROM, within the protocol converter 20. Through the configuration ROM, other devices within the IEEE 1394-1995 network 44 obtain identifying information about the converter 20.

The protocol converter 20 includes the IEEE 1394-1995 interface circuit 50 which is coupled to the IEEE 1394-1995 serial bus 30. Through the IEEE 1394-1995 interface circuit 50 the protocol converter 20 communicates with devices coupled within the IEEE 1394-1995 serial bus network 44. The protocol converter 20 also includes the CEBus interface circuit 54 which is coupled to the CEBus 32. Through the CEBus interface circuit 54 the protocol converter 20 communicates with devices coupled within the CEBus network 46.

Prior to using the protocol converter 20 to send a transmission or instruction to a CEBus device, an IEEE 1394-1995 device, such as the computer 24, first discovers the devices coupled to the IEEE 1394-1995 serial bus 30. During this discovery process, the IEEE 1394-1995 device determines that the protocol converter 20 is one of the devices coupled to the IEEE 1394-1995 network. The IEEE 1394-1995 device then sends a packet to the protocol converter 20 requesting information about the devices coupled to the protocol converter 20 through the CEBus 32. In the preferred embodiment of the present invention this packet is sent from the IEEE 1394-1995 device to the converter 20 using an IEEE 1394-1995 defined bus write transaction addressed to a function control protocol (FCP) command register within the IEEE 1394-1995 address space of the protocol converter 20, using the function control protocol as defined in the IEC 61883-1 standard. To respond to this write transaction from the IEEE 1394-1995 device, the converter 20 performs an IEEE 1394-1995 defined bus write transaction to the FCP response register within the IEEE 1394-1995 address space of the IEEE 1394-1995 device. These transactions sent between devices coupled together by the IEEE 1394-1995 serial bus 30 preferably conform to the AV/C Digital Interface Command Set. Alternatively, as should be apparent to those skilled in the art, any other appropriate command delivery protocols and command sets can be used for transactions between the devices coupled to the IEEE 1394-1995 serial bus 30.

After receiving the request from the IEEE 1394-1995 device, the protocol converter 20 performs appropriate CEBus operations to determine the devices coupled to the CEBus 32. After discovering the devices included within the CEBus network 46, the protocol converter 20 then sends a message to the requesting IEEE 1394-1995 device, in response to its request, informing the IEEE 1394-1995 device of the available CEBus devices. After learning of the available CEBus devices, the requesting IEEE 1394-1995 device is then able to communicate with or control devices within the CEBus network 46, through the protocol converter 20.

To communicate with a device within the CEBus network 46, an IEEE 1394-1995 device preferably sends an AV/C command to the protocol converter 24. Within this AV/C command, the IEEE 1394-1995 device includes a CEBus command for the intended CEBus device. After formulating the CEBus command for the intended CEBus device, the IEEE 1394-1995 device packetizes the CEBus command into the AV/C command frame such that the CEBus command is contained completely within the command dependent field of the AV/C command. This AV/C command is then sent from the IEEE 1394-1995 device to the protocol converter 20, over the IEEE 1394-1995 serial bus 30, using the FCP command delivery protocol. Preferably, this command has the following structure:

CTS, subunit ID, AVC opcode
CEBus addressing information
CEBus command
CEBus command
CEBus command
CEBus command

The CTS code, subunit identifier and AV/C opcode are required in all AV/C commands. The subunit identifier specifies the subunit to which the command is addressed. When the IEEE 1394-1995 device is sending a command to the protocol converter 20, the subunit identifier will include the identifier of the protocol converter 20. The AV/C opcode indicates that this is a CEBus command, such as a common application language (CAL) or Generic CAL format command, packetized into an AV/C command together with sufficient information for the protocol converter 20 to perform its function and transmit the CEBus command to the intended CEBus device. The CEBus addressing information is included within the parameter field of the AV/C command itself. The CEBus addressing information includes CEBus related information specifying to which CEBus device within the CEBus network 46 the CEBus command is to be delivered. The remainder of the AV/C command includes the CEBus command to be delivered to the intended CEBus device.

After receiving a command from an IEEE 1394-1995 device which is intended for a CEBus device, the protocol converter 20 separates the CEBus command from the AV/C command. The protocol converter 20 then performs the necessary CEBus operation to deliver the separated CEBus command to the intended CEBus device. The protocol converter 20 uses protocols and other mechanisms native to the intended device and to the CEBus, as necessary, in order to deliver the CEBus command to the intended CEBus device.

After receiving the CEBus command, the intended CEBus device, if appropriate, responds to this command by delivering a response to the protocol converter 20, using normal CEBus operations. After receiving this CEBus command, the protocol converter 20 recognizes that this is a response to the previous command frame from the initiating IEEE 1394-1995 device. The protocol converter 20 then encapsulates this received CEBus command response into an AV/C command response frame structure and sends the AV/C command response frame to the initiating IEEE 1394-1995 device over the IEEE 1394-1995 serial bus 30, using the FCP response delivery mechanism. After receiving this response frame from the protocol converter 20, the initiating IEEE 1394-1995 device will complete this transaction.

The protocol converter 20 of the preferred embodiment of the present invention receives communications from the sending bus structure, manipulates the received communications into the proper format for communications on the receiving bus structure and then transmits the manipulated communications to the appropriate device on the receiving bus structure. In the example above, the transaction was initiated by the IEEE 1394-1995 device to control a CEBus device. However, it should be apparent to those skilled in the art that the protocol converter 20 of the present invention will also convert transactions initiated by the CEBus devices into the proper format for the receiving device.

A communication from a device coupled to the IEEE 1394-1995 bus structure 30, directed to a device on the CEBus structure 32, is routed from the IEEE 1394-1995 serial bus 30 to the IEEE 1394-1995 physical interface 50 of the converter 20 The microprocessor 52 then reads the communication received from the IEEE 1394-1995 interface 50 and performs the necessary manipulations to the communication in order to configure the communication in the proper format for the CEBus structure 32. The appropriately configured communication is then routed through the CEBus interface 54 onto the CEBus structure 32. The communication is then routed to the appropriate receiving device on the CEBus structure 32.

A communication from a device coupled to the CEBus structure 32 to a device on the IEEE 1394-1995 bus structure 30, is routed from the CEBus structure 32 to the CEBus interface 54 of the converter 20. The microprocessor 52 then reads the communication received from the CEBus interface 54 and performs the necessary manipulations to the communication in order to configure the communication in the proper format for the IEEE 1394-1995 serial bus structure 30. The appropriately configured communication is then routed through the IEEE 1394-1995 serial bus interface 50 onto the IEEE 1394-1995 serial bus structure 30. The communication is then routed to the appropriate receiving device on the IEEE 1394-1995 serial bus structure 30.

Within the exemplary networks of devices illustrated in FIG. 2, a protocol converter of the present invention can be used to allow the computer 24, within the IEEE 1394-1995 serial bus network 44 to communicate and control the irrigation system 42, within the CEBus network 46. After discovering that the protocol converter 20 is coupled to the IEEE 1394-1995 serial bus 30, the computer system 24 then sends a communication to the protocol converter 20 requesting information about the devices coupled to the protocol converter 20 through the CEBus 32. The protocol converter 20 then determines the devices coupled to the CEBus 32. The protocol converter 20 then sends a communication to the computer system 24 informing the computer system 24 that the lighting system 36, the air-conditioning and heating system 38, the security system 40 and the irrigation system 42 are all coupled to the CEBus 32.

To control the operation of the irrigation system 42 through the computer system 24, a user enters the control and scheduling information into the computer system 24. At the appropriate time, the computer system 24 then sends a communication to the protocol converter including a packetized CEBus command directed to the irrigation system 42. After receiving the command from the computer system 24, the protocol converter separates the CEBus command. The protocol converter 20 then performs the necessary CEBus operation to deliver the separated CEBus command to the irrigation system 42. After receiving the command from the protocol converter 20, the irrigation system 42, if appropriate, will send a response to the protocol converter 20. If the protocol converter 20 receives a response from the irrigation system 42, the response is encapsulated into an AV/C command response frame structure and sent to the computer system 24 over the IEEE 1394-1995 serial bus 30. In this manner, using the protocol converter 20 of the present invention, an IEEE 1394-1995 device, such as the computer system 24, can communicate with and control a CEBus device, such as the irrigation system 42. Correspondingly, a CEBus device can also communicate with and control an IEEE 1394-1995 device using the protocol converter 20.

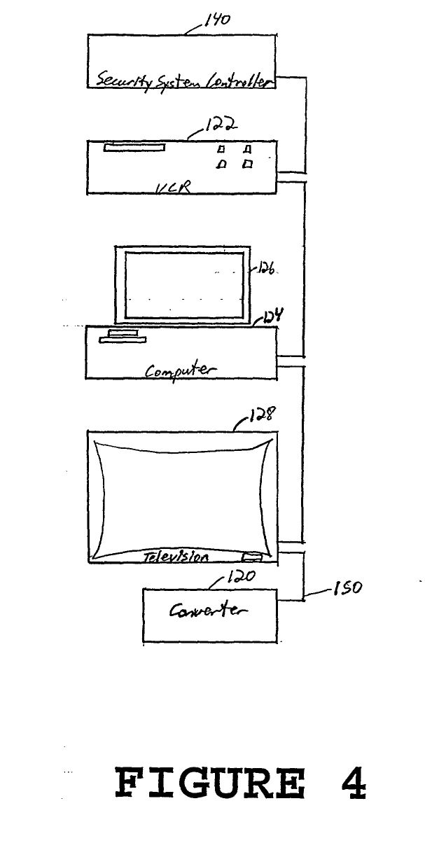

A block diagram of a protocol converter of an alternate embodiment of the present invention, coupled to an exemplary bus structure and network of devices is illustrated in FIG. 4. A security system controller 140 is coupled to a VCR 122. The VCR 122 is coupled to a computer 124. The computer 124 also includes an associated monitor 126. A television 128 is coupled to the computer 124 and to the converter 120. The security system controller 140, VCR 122, computer 124, television 128 and converter 120 are coupled to the bus structure 150. In this exemplary network of devices the security system controller 140 operates using a different protocol than the other devices within the network.

The protocol converter 120 allows communications to be sent over the bus structure 150, between the security system controller 140, operating under a first protocol, and the other devices within the network, operating under a second protocol. When communications are sent from a device, operating under the second protocol, such as the computer 124, to the security system controller 140, operating under the first protocol, the communications are first routed to the converter 120. The converter 120 converts the communication into the proper format for the first protocol and then sends the communication over the bus structure 150 to the security system controller 140. Similarly, when communications are sent from the security system controller 140 over the bus structure 150 to another device, such as the computer 124, the communications are first routed to the converter 120. The converter 120 then converts the communications into the proper format for the second protocol, as described above, and sends the communication over the bus structure 150 to the computer system 124.

In this manner, a device, such as the security system controller 140, operating under a first protocol, and the other devices, operating under a second protocol, can communicate with each other over the bus structure 150. Communications between devices operating under different protocols are routed through the converter 120 which converts the communications into the proper protocol for the receiving device. The converter 120 then sends the communication to the receiving device.

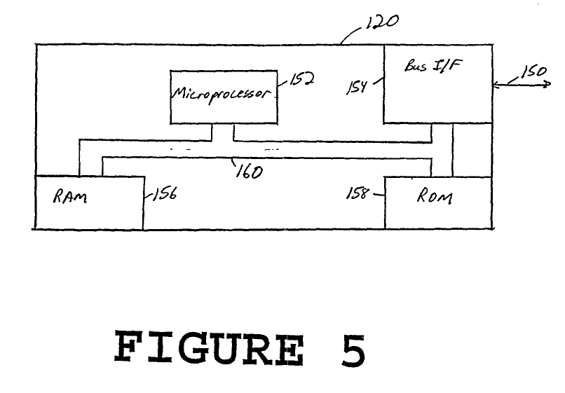

A detailed block diagram schematic of the protocol converter 120 of this alternate embodiment is illustrated within FIG. 5. The protocol converter 120 includes a bus interface circuit 154, a microprocessor 152, a RAM 156 and a ROM 158, all coupled together by a system bus 160. The bus interface circuit 154 is coupled to the bus structure 150 to receive communications from and send communications to the other devices on the bus structure 150. Other than having a single bus interface 154, the protocol converter 120 operates in the same manner as the protocol converter 20, described above, to convert communications into the proper protocol.

A protocol converter 20 of the present invention, as described above, will appropriately convert communications directed from a device operating under a first protocol to a device operating under a second protocol. The protocol converter 20 preferably includes a microprocessor 52 to control the manipulation of communications into the proper format and then transmit the manipulated communications to the receiving device. A protocol conversion program is preferably stored within a ROM in the converter 20 and used by the microprocessor 52 to perform the appropriate conversions. Alternatively, the converter 20 is programmed for the appropriate conversions by a device on one of the bus structures. In still a further alternate embodiment, the protocol converter 20 includes fixed firmware for performing the appropriate conversions. In the preferred embodiment of the present invention, the converter 20 is coupled between two bus structures of different protocols, where one of the bus structures is an IEEE 1394-1995 bus structure. Alternatively, the converter and the devices are all coupled to the same bus structure. In the preferred embodiment, as communications are directed from the IEEE 1394-1995 bus structure 30 to devices on the other bus structure 32, the converter 20 will manipulate those communications into the appropriate protocol for communications on the other bus structure 32. As communications are directed from the other bus structure 32 to devices on the IEEE 1394-1995 bus structure 30, the converter 20 will manipulate those communications into the appropriate protocol for communications on the IEEE 1394-1995 bus structure 30. It should be apparent to those skilled in the art that while the operation of the protocol converter 20 of the present invention has been illustrated between devices of an IEEE 1394-1995 serial bus network and devices of a CEBus network, the protocol converter 20 of the present invention can be used to convert communications into any other appropriate protocols for devices coupled to the protocol converter.

Preferably, the protocol converter 20 of the present invention is implemented as a separate device coupled between two or more devices of different protocols. Alternatively, the protocol converter 20 of the present invention can also be implemented within any appropriate device configured to couple to the two or more devices of different protocols.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

We claim:

1. A converter configured for coupling between two devices operating under different protocols for converting communications between the two devices into proper formats, comprising:
a. a first interface circuit configured for coupling to a first device operating under a first protocol;
b. a second interface circuit configured for coupling to a second device operating under a second protocol; and
c. a conversion circuit coupled between the first and second interface circuits for converting communications directed to the second device into the second protocol.

2. The converter as claimed in claim 1 wherein the first device is coupled within an IEEE 1394 bus structure.

3. The converter as claimed in claim 1 wherein the conversion circuit is programmed by the first device.

4. The converter as claimed in claim 3 wherein the communications are in one of an isochronous format and an asynchronous format.

5. The converter as claimed in claim 4 wherein the first device is coupled within an IEEE 1394 bus structure.

6. The converter as claimed in claim 5 wherein the conversion circuit also converts communications directed to the first device into the first protocol.

7. The converter as claimed in claim 6 wherein the second device is coupled within a CEBus network.

8. The converter as claimed in claim 6 wherein the second device is coupled within a Lonworks network.

9. The converter as claimed in claim 6 wherein the second device is coupled within a AVBus network.

10. The converter as claimed in claim 6 wherein the second device is coupled within a CAL-based network.

11. The converter as claimed in claim 6 wherein the second device is coupled within a Generic CAL-based network.

12. A converter configured for coupling between two devices operating under different protocols for converting communications between the two devices into proper formats, comprising:
a. an interface circuit configured for coupling to a first device operating under a first protocol and a second device operating under a second protocol; and
b. a conversion circuit coupled to the interface circuit for converting communications directed to the second device into the second protocol.

13. The converter as claimed in claim 12 wherein the interface circuit is coupled to the first and second devices by a bus structure.

14. The converter as claimed in claim 13 wherein the conversion circuit also converts communications directed to the first device into the first protocol.

15. A converter configured for coupling between two bus structures operating under different protocols for converting communications between the two devices into proper formats, comprising:
a. a first interface circuit configured for coupling to a first bus structure including a first plurality of devices operating under a first protocol;
b. a second interface circuit configured for coupling to a second bus structure including a second plurality of devices operating under a second protocol; and
c. a conversion circuit coupled between the first and second interface circuits for converting communications directed from one of the second plurality of devices to one of the first plurality of devices into the first protocol and communications directed from one of the first plurality of devices to one of the second plurality of devices into the second protocol.

16. The converter as claimed in claim 15 wherein the first bus structure is an IEEE 1394 serial bus structure.

17. The converter as claimed in claim 16 wherein the conversion circuit is programmed by a device within the first bus structure.

18. The converter as claimed in claim 17 wherein the communications are in one of an isochronous format and an asynchronous format.

19. A network of devices operating under a plurality of protocols comprising:
a. a first plurality of devices coupled together within a first bus structure and operating under a first protocol;
b. a second plurality of devices coupled together within a second bus structure and operating under a second protocol; and
c. a converter coupled between the first plurality of devices and the second plurality of devices for converting communications between the first and second pluralities into proper formats, the converter including:
i. a first interface circuit coupled to the first bus structure;
ii. a second interface circuit coupled to the second bus structure; and
iii. a conversion circuit coupled between the first and second interface circuits for converting communications directed from one of the first plurality of devices to one of the second plurality of devices into the second protocol.

20. The network of devices as claimed in claim 19 wherein the first bus structure is an IEEE 1394 serial bus structure.

21. The network of devices as claimed in claim 20 wherein the conversion circuit also converts communications directed from one of the second plurality of devices to one of the first plurality of devices into the first protocol.

22. The network of devices as claimed in claim 21 wherein the conversion circuit is programmed by a device within the first bus structure.

23. The network of devices as claimed in claim 22 wherein the communications are in one of an isochronous format and an asynchronous format.

24. The network of devices as claimed in claim 23 wherein the second bus structure is a CEBus network.

25. The network of devices as claimed in claim 23 wherein the second bus structure is a Lonworks network.

26. The network of devices as claimed in claim 23 wherein the second bus structure is a AVBus network.

27. The network of devices as claimed in claim 23 wherein the second bus structure is a CAL-based network.

28. The network of devices as claimed in claim 23 wherein the second bus structure is a Generic CAL-based network.
